(19) United States
(12) Patent Application Publication
(10) Pub. No.: US 2024/0422070 A1
(43) Pub. Date: Dec. 19, 2024

(54) METHOD, APPARATUS, ELECTRONIC DEVICE AND STORAGE MEDIUM FOR NETWORK TOPOLOGY-BASED VERIFICATION

(71) Applicants: Lemon Inc., Grand Cayman (KY); Beijing Youzhuju Network Technology Co., Ltd., Pinggu District (CN)

(72) Inventors: Weirong Jiang, Los Angeles, CA (US); Anubhavnidhi Abhashkumar, Los Angeles, CA (US); Zhaoyu Gao, Los Angeles, CA (US); Yi Wang, Los Angeles, CA (US); Jian Wang, Beijing (CN)

(21) Appl. No.: 18/743,730

(22) Filed: Jun. 14, 2024

(30) Foreign Application Priority Data
Jun. 14, 2023 (CN) 202310710403.4

(51) Int. Cl. H04L 41/14; H04L 41/12

(52) U.S. Cl. CPC H04L 41/145; H04L 41/12

(57) ABSTRACT

The disclosure provides a method, an apparatus, an electronic device and a storage medium for network topology-based verification. The method comprises: obtaining a network verification request which comprises device change information for a physical network; determining a target network device changed in the physical network using the device change information, and obtaining extended network devices from network devices in each of the hierarchical layers in the physical network, the extended network devices obtained in each of the hierarchical layers corresponding to different providers; constructing an emulated network topology based on the target network device and the extended network devices; and establishing an emulation runtime environment corresponding to the emulated network topology, and performing emulation verification on the emulated network topology based on the emulation runtime environment to obtain an emulation verification result.

### CROSS REFERENCE

The present application claims priority to Chinese Patent Application No. 202310710403.4, filed on Jun. 14, 2023 and entitled “METHOD, APPARATUS, ELECTRONIC DEVICE AND STORAGE MEDIUM FOR NETWORK TOPOLOGY-BASED VERIFICATION”, the entirety of which is incorporated herein by reference.

### FIELD

The present disclosure relates to the field of network emulation, and in particular, to a method, an apparatus, an electronic device, and a storage medium of network topology-based verification.

### BACKGROUND

Network emulation is mainly used to verify the configuration of switches and evaluate potential risks that configuration changes bring to a physical network. Its main work is to create a 1:1 replica of a physical network of an emulation network environment by utilizing a network virtualization technology based on the requirement of network changes, thereby enabling the verification of network changes in the emulation network environment.

Current network emulation solutions lack a means to automatically establish a network topology, and still require manual operation to achieve the process of establishing the network topology. Therefore, when it comes to the construction of a large-scale network emulation environment, the existing methods have great difficulty in realizing network emulation verification due to the inability to automatically establish the network topology.

### SUMMARY

In view of this, embodiments of the present disclosure provide a method, an apparatus, an electronic device, and a storage medium of topology-based verification, to address the problem in the prior art, which has great difficulty in realizing network emulation verification due to the inability to automatically establish the network topology.

In a first aspect, the embodiments of the present disclosure provide a method of network topology-based verification, where the method comprises: obtaining a network verification request, wherein the network verification request comprises device change information for a physical network, the physical network comprises a plurality of hierarchical layers, and each of the hierarchical layers comprises a plurality of network devices; determining a target network device changed in the physical network using the device change information, and obtaining extended network devices from network devices in each of the hierarchical layers in the physical network, wherein the extended network devices obtained in each of the hierarchical layers correspond to different providers; constructing an emulated network topology based on the target network device and the extended network devices; and establishing an emulation runtime environment corresponding to the emulated network topology, and performing emulation verification on the emulated network topology based on the emulation runtime environment to obtain an emulation verification result.

In a second aspect, the embodiments of the present disclosure provide an apparatus for network topology-based verification, where the apparatus comprises: an obtaining module configured to obtain a network verification request, wherein the network verification request comprises device change information for a physical network, the physical network comprises a plurality of hierarchical layers, and each of the hierarchical layers comprises a plurality of network devices; a determining module configured to determine a target network device changed in the physical network using the device change information, and obtain extended network devices from network devices in each of the hierarchical layers in the physical network, wherein the extended network devices obtained in each of the hierarchical layers correspond to different providers; a constructing module configured to construct an emulated network topology based on the target network device and the extended network devices; and a performing module configured to establish an emulation runtime environment corresponding to the emulated network topology, and perform emulation verification on the emulated network topology based on the emulation runtime environment to obtain an emulation verification result.

In a third aspect, the embodiments of the present disclosure provide a computer device, comprising: a memory and a processor, where the memory and the processor are in communication with each other, the memory stores computer instructions which are executed by the processor to perform the method of network topology-based verification according to the first aspect or any embodiment corresponding thereto.

In a fourth aspect, the embodiments of the present disclosure provide a computer-readable storage medium having computer instructions stored thereon, where the computer instructions are configured to cause a computer to perform the method of network topology-based verification according to the first aspect or any embodiment corresponding thereto.

### DESCRIPTION OF THE DRAWINGS

In order to more clearly illustrate the detailed description of the present disclosure or the technical solutions in the prior art, the drawings used in the detailed description or the prior art descriptions will be briefly described below, it is obvious that the drawings in the following description are some embodiments of the present disclosure, and other drawings can be obtained by those skilled in the art without creative efforts.

FIG. 1 is a schematic flow diagram of a method of network topology-based verification according to some embodiments of the present disclosure;

FIG. 2 is a schematic diagram of a physical network according to some embodiments of the present disclosure;

FIG. 3 is a schematic diagram of a physical network according to some embodiments of the present disclosure;

FIG. 4 is a schematic diagram of an emulated network topology according to some embodiments of the present disclosure;

FIG. 5 is a connection relationship diagram of a target host according to some embodiments of the present disclosure;

FIG. 6 is a block diagram of an apparatus for network topology-based verification according to an embodiment of the present disclosure; and

FIG. 7 is a hardware structural diagram of an electronic device according to an embodiment of the present disclosure.

### DETAILED DESCRIPTION

To make the objects, technical solutions and advantages of the embodiments of the present disclosure more apparent, the technical solutions in the embodiments of the present disclosure will be described clearly and completely with reference to the drawings in the embodiments of the present disclosure, and it is obvious that the described embodiments are some, but not all embodiments of the present disclosure. All other embodiments, which can be derived by a person skilled in the art from the embodiments disclosed herein without making any creative effort, shall fall within the protection scope of the present disclosure.

According to the embodiments of the present disclosure, there are provided a method, an apparatus, an electronic device and a storage medium for network topology-based verification, it should be noted that the steps shown in the flowchart of the drawings may be executed in a computer system such as a set of computer executable instructions, and although a logical order is shown in the flowchart, in some cases, the steps shown or described may be executed in an order different from that of the flowchart.

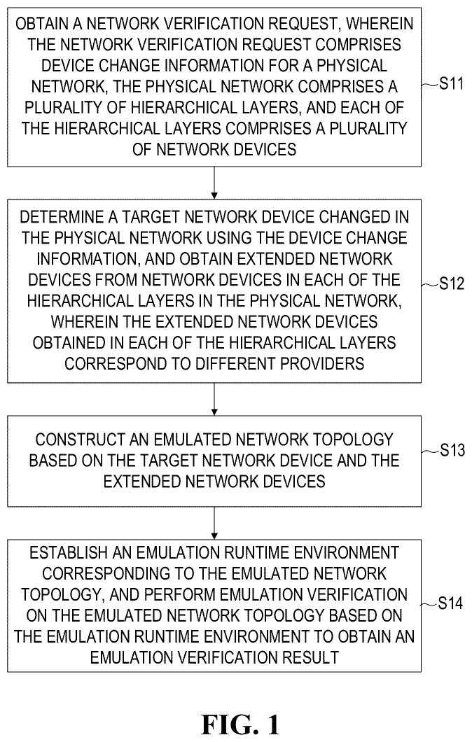

In the embodiments of the present disclosure, a method of network topology-based verification is provided, which may be used in an intelligent terminal, such as a computer, a tablet computer, and the like, and FIG. 1 is a flowchart of the method of network topology-based verification according to the embodiments of the present disclosure, as shown in FIG. 1, the flow includes the following steps.

At step S11, a network verification request is obtained. The network verification request comprises device change information for a physical network, the physical network comprises a plurality of hierarchical layers, and each of the hierarchical layers comprises a plurality of network devices.

In the embodiments of the present disclosure, the intelligent terminal is deployed with a network verification platform, and a user triggers the network verification request based on the network verification platform. The network verification request comprises device change information for a physical network, the physical network comprises a plurality of hierarchical layers, and each of the hierarchical layers comprises a plurality of network devices. The network devices may be switches.

Specifically, the network verification platform may receive a list of device names uploaded by the user, where the list of device names includes a device name of at least one changed device in the physical network, and the network verification platform queries, by using the device name, the device change information corresponding to the changed device. The device change information may include the device name, device information of a newly added device in the physical network, the device information of a replaced device, or device configuration information after a device in the physical network is changed, and the like. At last, the request is verified based on the physical network in device change information.

At step S12, a target network device changed in the physical network is determined using the device change information, and extended network devices are obtained from network devices in each of the hierarchical layers in the physical network. The extended network devices obtained in each of the hierarchical layers correspond to different providers.

In the embodiments of the present disclosure, the device name in the device change information is used to determine the target network device changed in the physical network, and the hierarchical layer of the target network device in the physical network is determined. Then, the network devices of the upper hierarchical layer, the lower hierarchical layer, and the same hierarchical layer of the device are traversed based on the target network device of the hierarchical layer in the physical network, to obtain the extended network devices which is finally used for constructing the emulated network topology. The providers corresponding to the extended network devices at each of the hierarchical layers are different, for example: the current hierarchical layer of the target network device is a third hierarchical layer. The extended network devices obtained from the upper hierarchical layer (the second hierarchical layer) of the network device include: device 2 and device 3, where device 2 corresponds to vendor A and device 3 corresponds to vendor B. The extended network devices obtained from the lower hierarchical layer (the fourth hierarchical) of the network devices comprise: device 5 and device 7, where device 5 corresponds to vendor A and device 7 corresponds to vendor C.

Specifically, the obtaining extended network devices from network devices in each of the hierarchical layers in the physical network comprises the following steps A1-A3.

At step A1, the physical network is traversed to obtain a set of upstream network devices and a set of downstream network devices associated with the target network device, where the set of upstream network devices comprise target upstream network devices at the plurality of hierarchical layers, and the set of downstream network devices comprise target downstream network devices at the plurality of hierarchical layers.

In the embodiments of the present disclosure, the traversing the physical network to obtain a set of upstream network devices and a set of downstream network devices associated with the target network device comprises the following steps A101-A104.

At step A101, the physical network is traversed to obtain a first set of devices at an upper hierarchical layer than that of the target network device and a second set of devices at a lower hierarchical layer than that of the target network device, where the first set of devices comprises a plurality of upstream network devices, and the second set of devices comprises a plurality of downstream network devices.

In the embodiments of the present disclosure, the physical network may be traversed simultaneously to obtain the first set of devices at the upper hierarchical layer (i.e., upstream) than that of the target network device and the second set of devices at the lower hierarchical layer (i.e., downstream) than that of the target network device, where the first set of devices comprises all upstream network devices at the hierarchical layer, and the second set of devices comprises all downstream network devices at the hierarchical layer.

At step A102, a set of first providers corresponding to the first set of devices and a set of second providers corresponding to the second set of devices are determined, where the set of first providers comprises a plurality of different first providers, and the set of second providers comprises a plurality of different second providers.

In the embodiments of the present disclosure, the first providers corresponding to respective upstream network devices in the first set of devices are queried, and the first set of providers is constructed based on the first providers. The second providers corresponding to respective downstream network devices in the second set of devices are queried, and the second set of providers is constructed based on the second providers.

As an example, the first set of devices includes device 2, device 3, and device 4, where device 2 corresponds to vendor A, device 3 corresponds to vendor B, and device 4 corresponds to vendor B. The first set of providers at this time includes: provider A and provider B. The second set of devices includes device 5, device 6, and device 8, where device 5 corresponds to vendor A, device 6 corresponds to vendor A, and device 8 corresponds to vendor C. The first set of providers at this time includes: provider A and provider C.

At step A103, an upstream network device corresponding to each of the first providers is selected from the first set of devices as the target upstream network device, and the target upstream network device is added to the set of upstream network devices.

In the embodiments of the present disclosure, if there are a plurality of upstream network devices corresponding to the first provider in the first set of devices, an upstream network device corresponding to the first provider may be arbitrarily selected from the first set of devices as the target upstream network device. The target upstream network device is added to the set of upstream network devices.

In the embodiments of the present disclosure, after selecting an upstream network device corresponding to each of the first providers from the first set of devices as the target upstream network device, and adding the target upstream network device to the set of upstream network devices, the method further comprises: detecting whether respective upstream network devices in the first set of devices belong to a root node, to obtain a first detection result; determining an upstream network device with the first detection result of not belonging to a vertex as a reference upstream network device, and traversing the physical network to obtain a third set of devices of an upper hierarchical layer of the reference upstream network device, wherein the third set of devices comprises a plurality of upstream network devices; determining a set of third providers corresponding to the third set of devices, wherein the set of third providers comprises a plurality of different third providers; and selecting an upstream network device corresponding to each of the third providers from the third set of devices as the target upstream network device, and adding the target upstream network device to the set of upstream network devices until the upstream network devices belonging to the root node have been traversed.

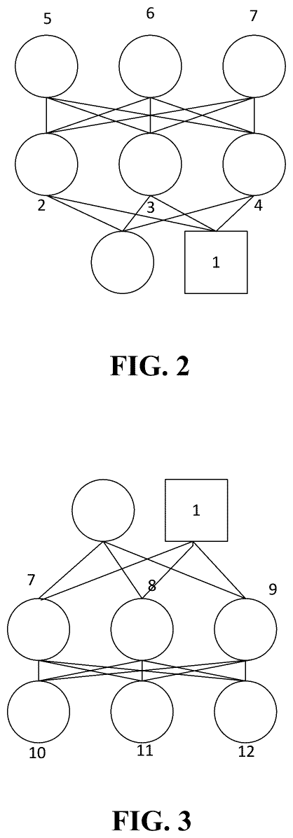

As an example, as shown in FIG. 2, target network device 1 is at the third hierarchical layer in the physical network, and at this time, upstream network devices at the previous hierarchical layer of the hierarchical layer of target network device 1 are traversed, to obtain the first set of devices, where the first set of devices includes device 2, device 3 and device 4. Providers corresponding to respective devices in the first set of devices are queried, where device 2 corresponds to provider A, device 3 corresponds to provider B, and device 4 corresponds to provider B. At this point, the first set of providers (A, B) is obtained and device 2 and device 3 (or device 4) are added to the set of upstream network devices.

Then, whether device 2, device 3, and device 4 belong to the root node is determined. Based on the physical network, it is known that device 2, device 3, and device 4 do not belong to the root node, and at this time, the previous hierarchical layers of device 2, device 3, and device 4 are traversed to obtain the third set of devices, where the third set of devices includes: device 5, device 6 and device 7. The providers corresponding to respective devices in the third set of devices, where device 5 corresponds to provider A, device 6 corresponds to provider B, and device 7 corresponds to provider B. At this point, the third set of providers (A, B) is obtained, and device 5 and device 6 (or device 7) are added to the set of upstream network devices. Whether device 5, device 6 and device 7 belong to the root node is determined, and if so, the traversal is stopped. The finally obtained set of upstream network devices includes device 2, device 3 (or device 4), device 5, and device 6 (or device 7).

It should be noted that, because the upstream devices of different providers behave differently in the network environment, when traversing the upstream network devices at each of the hierarchical layers, the corresponding provider is determined, and then any of the upstream network devices corresponding to the respective providers is added to the set of upstream network devices. Based on this, in the traversing process, the upstream network devices of different providers are obtained at each of the hierarchical layers, so that behaviors of the devices of respective providers can be included in the subsequent emulation, and accuracy of the emulation is improved.

At step A104, a downstream network device corresponding to each of the second providers is selected from the second set of devices as the target downstream network device, and the target downstream network device is added to the set of downstream network devices.

In the embodiments of the present disclosure, if there are the plurality of downstream network devices corresponding to the second provider in the second set of devices, the downstream network device corresponding to the second provider may be arbitrarily selected from the second set of devices as the target downstream network device. The target downstream network device is added to the set of downstream network devices.

In the embodiments of the present disclosure, after selecting a downstream network device corresponding to each of the second providers from the second set of devices as the target downstream network device, and adding the target downstream network device to the set of downstream network devices, the method further comprises: detecting whether respective downstream network devices in the second set of devices belong to a leaf node, to obtain a second detection result; determining a downstream network device with the second detection result of not belonging to the leaf node as a reference downstream network device, and traversing the physical network to obtain a fourth set of devices of a lower hierarchical layer of the reference downstream network device, wherein the fourth set of devices comprises a plurality of downstream network devices; determining a fourth provider set corresponding to the fourth set of devices, wherein the fourth provider set comprises a plurality of different fourth providers; and selecting a downstream network device corresponding to each of the fourth providers from the fourth set of devices as the target downstream network device, and adding the target downstream network device to the set of downstream network devices until the downstream network devices belonging to the leaf node have been traversed.

As an example, as shown in FIG. 3, target network device 1 is at the third hierarchical layer in the physical network, and then the downstream network device at the next hierarchical layer of target network device 1 is traversed to obtain the first set of devices, where the second set of devices includes device 8, device 9 and device 10. The providers corresponding to respective devices in the second set of devices are queried, where device 8 corresponds to provider A, device 9 corresponds to provider B, and device 10 corresponds to provider B. At this point, a second set of providers (A, B) is obtained, and device 8 and device 9 (or device 10) are added to the set of downstream network devices.

Then, whether device 8, device 9, and device 10 belong to the root node is determined, and based on the physical network, it is known that device 8, device 9, and device 10 do not belong to the root node, and at this time, the next hierarchical layers of device 8, device 9, and device 10 are traversed to obtain a fourth device set, where the fourth device set includes device 11, device 12 and device 13. Providers corresponding to respective devices in the fourth device set are queried, where device 11 corresponds to provider A, device 12 corresponds to provider B, and device 13 corresponds to provider B. At this point, a third set of providers (A, B) is obtained, and device 11 and device 12 (or device 13) are added to the downstream set of network devices. Whether device 11, device 12, and device 13 belong to the root node is determined, and if so, the traversal is stopped. The finally obtained set of downstream network devices includes device 8, device 9 (or device 10), device 11, and device 12 (or device 13).

It should be noted that, because the downstream devices of different providers behave differently in the network environment, when traversing the downstream network devices of each of the hierarchical layers, the corresponding provider is determined, and then any of the downstream network devices corresponding to the respective providers is added to the set of downstream network devices. Based on this, in the traversing process, the downstream network devices of different providers are obtained at each of the hierarchical layers, so that the behaviors of the devices of the providers can be included in the subsequent emulation, and accuracy of the emulation is improved.

At step A2, the physical network is traversed to obtain a target neighboring device at a same hierarchical layer as the target network device.

In the embodiments of the present disclosure, the traversing the physical network to obtain a target neighboring device at a same hierarchical layer as the target network device comprises the following steps A201-A202.

At step A201, the physical network is traversed to obtain candidate neighboring devices at a same hierarchical layer as the target network device.

At step A202, a candidate neighboring device with no device change is determined as the target neighboring device.

In the embodiments of the present disclosure, the physical network is traversed to obtain the candidate neighbor devices at the same hierarchical layer as the target network device, and the candidate neighbor devices may include devices that have been changed and devices that have not been changed. In order to accurately obtain the influence of the target network device on the network after the change, the candidate neighbor device that has not undergone device change at the same hierarchical layer needs to be determined as the target neighbor device, where the number of the candidate neighbor devices may be set based on requirements of the emulation.

It should be noted that, if only the upstream network devices and the downstream network devices of the target network device are obtained, the influence of the target network device cannot be obtained in the emulation network, and meanwhile, since the target network device also affects the devices at the same hierarchical layer, accuracy of the emulation can be improved in the subsequent emulation by obtaining the neighbor device at the same hierarchical layer.

At step A3, the target upstream network devices, the target downstream network devices, and the target neighboring device are determined as the extended network devices.

In the embodiments of the present disclosure, respective target upstream network devices in the upstream network devices, respective target downstream network devices in the downstream network devices, and the target neighbor device are determined as the extended network devices.

At step S13, an emulated network topology is constructed based on the target network device and the extended network devices.

In the embodiments of the present disclosure, the establishing an emulated network topology based on the target network device and the extended network devices comprises the following steps B1-B2.

At step B1, a first connection relationship between the target network device and the extended network devices, and second connection relationships between respective ones of the extended network devices are determined.

In the embodiments of the present disclosure, according to the hierarchical relationship in the physical network, extended network devices at the upper hierarchical layer and the lower hierarchical layer of the target network device are obtained from the extended network device, and are determined as a first extended network device. The target network device is directly connected to the first extended network device.

At step B2, the emulated network topology is established based on the target network device, the extended network devices, the first connection relationship, and the second connection relationships.

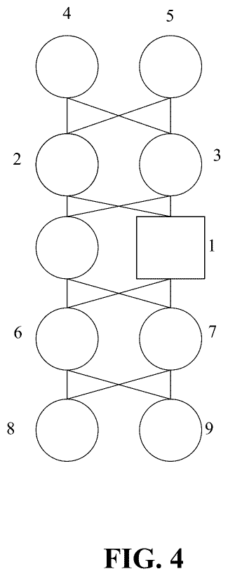

In the embodiments of the present disclosure, as shown in FIG. 4, the target network device in the emulated network topology includes: the extended network devices include: the target network device is device 1, and the extended network devices include: device 2, device 3, device 4, device 5, device 6, device 7, device 8, and device 9. The first connection relationship includes: a connection relationship of device 1 with device 2, device 3, device 6, and device 7. The second connection relationship includes: the connection relationship of device 2 with device 4 and device 5, and the connection relationship of device 3 with device 4 and device 5, the connection relationship of device 6 with device 8 and device 9, and the connection relationship of device 7 with device 8 and device 9.

In the embodiments of the present disclosure, the method further comprises the following steps C1-C3.

At step C1, a set of links between every two network devices in the emulated network topology are obtained, where the set of links comprises at least an original link for connecting two network devices.

In the embodiments of the present disclosure, the presence of too many links in the emulated network topology may result in a large performance overhead, for example, it may reduce overall speed, or trial starting time. Therefore, links between network devices in the emulated network topology need to be pruned in order to reduce performance overhead.

Specifically, the set of links between every two network devices in the emulated network topology is obtained, where the set of links includes at least an original link used for connecting two network devices. For example, the emulated network topology comprises device 1, device 2 and device 3, and the set of links between device 1 and device 2 comprises link a, link b, and link c. The set of links between device 2 and device 3 includes link d, link e, link f, and link g.

At step C2, the original link in the set of links is pruned to obtain a pruned target link. At step C3, the set of links is updated based on the target link.

In the embodiments of the present disclosure, the pruning the original link in the set of links to obtain a pruned target link comprises: removing a first link number of original links from the set of links to obtain a second link number of remaining original links; comparing the second link number with a predetermined link number; and in response to the second link number being greater than or equal to the predetermined link number, determining the remaining original links corresponding to the second link number as the target link.

As an example, the emulated network topology includes device 1, device 2 and device 3, and the set of links between device 1 and device 2 includes 7 links. The set of links between device 2 and device 3 includes 9 links. Taking device 2 and device 3 as an example for illustration, 3 (the first link number) original links are removed from the set of links, and then the remaining 6 (the second link number) original links in the set of links are the remaining original links. The second link number (6) is compared with the predetermined link number (5), and the second link number is greater than the predetermined link number, therefore the remaining original links corresponding to the second link number are determined as the target link. It should be noted that the predetermined link number may be understood as the number of links that ensures effect of the emulation, and in response to the second link number being greater than the predetermined link number, the original links are not only pruned, but also retained, which is beneficial to improving effect of the emulation.

In the embodiments of the present disclosure, in response to the second link number being less than the predetermined link number, a difference value between the second link number and the predetermined link number is determined; an original link corresponding to the difference value is obtained from the first link number of original links; and the original link corresponding to the difference value and the remaining original links corresponding to the second link number are determined as the target link.

As an example, taking device 1 and device 2 as an example for explanation, the set of links between device 1 and device 2 includes 7 links. 3 (the first number of links) original links are removed from the set of links, and the remaining 4 (the second number of links) original links in the set of links are the remaining original links. The second link number (4) is compared with the predetermined link number (5), and the second link number is smaller than the predetermined link number, which indicates that if only the remaining original links corresponding to the second link number are reserved, effect of the emulation cannot be satisfied. Therefore, the difference value (1) between the second link number and the predetermined link number is determined; and 1 original link is obtained from the 3 original links which have been removed before, and the original link and the remaining original links corresponding to the second link number (5) are determined as the target link. It should be noted that when the second link number is smaller than the predetermined link number, it is indicated that effect of the emulation cannot be satisfied after the original links are pruned, and a corresponding number of links need to be obtained from the removed original links, so as to ensure the effect of the emulation.

At step S14, an emulation runtime environment corresponding to the emulated network topology is established, and emulation verification on the emulated network topology is performed based on the emulation runtime environment to obtain an emulation verification result.

In the embodiments of the present disclosure, the establishing an emulation runtime environment corresponding to the emulated network topology comprises the following steps D1-D4.

At step D1, a hierarchical layer number of the emulated network topology is obtained.

At step D2, a corresponding number of target hosts is determined based on the hierarchical layer number, and a container number in the target hosts is determined based on a device number of network devices at each hierarchical layer.

In the embodiments of the present disclosure, the corresponding number of target hosts may be set based on the hierarchical layer number. For example, if the hierarchical layer number is 5, 5 target hosts may be set. Then, the device number of the network devices at each of the hierarchical layers is obtained, and the container number in the target hosts is determined based on the device number. For example, if the device number of the network devices at each of the hierarchical layers is 2, the container number in each of the target hosts may be determined as 2.

At step D3, the container number of containers are deployed in the target hosts.

In the embodiments of the present disclosure, the deploying the container number of containers in the target hosts comprises: determining a virtual machine to be deployed to respective containers in the host, and obtaining a virtual machine image and a virtual machine boot program of the virtual machine; generating a container image based on the virtual machine image, the virtual machine boot program and a predetermined software library; and creating the container using the container image.

At step D4, a connection relationship between respective containers in the target hosts and a connection relationship between containers in different target hosts are established, to obtain the emulation runtime environment.

In the embodiments of the present disclosure, the establishing a connection relationship between respective containers with the target hosts and a connection relationship between containers in different target hosts, to obtain the emulation runtime environment, comprises the following steps E1-E3.

At step E1, respective containers in the target hosts are connected through virtual network card ports in the containers.

At step E2, Ethernet interfaces of respective containers in the target hosts are connected to first bridges, and the first bridges in respective target hosts are connected using a network tunnel.

At step E3, management interfaces of respective containers in the target hosts are connected to second bridges, and the second bridges in the respective target hosts are connected to obtain the emulation runtime environment.

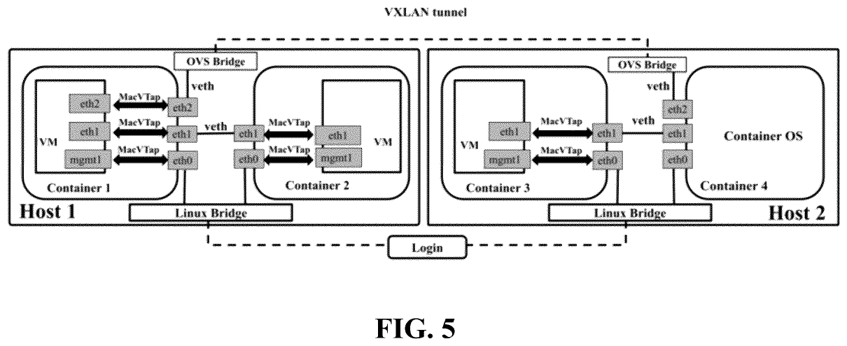

In the embodiments of the present disclosure, for containers in the same target host, the containers may be directly connected using the virtual network card port (veth), as shown in FIG. 5, a container (container1) in the target host (Host 1) is connected with a container (container2) by using the virtual network card port. The network interface of a virtual machine in the container is communicated with a network interface of an external container through MacvTap interface, and one-to-one mapping is implemented.

In the embodiments of the present disclosure, for different target hosts, as shown in FIG. 5, the Ethernet interface (eth) of the container (container1) in the target host (Host 1) is connected to the first bridge (OVS Brkdge) in the target host (Host 1), and the container (container3) in the target host (Host 2) is connected to the first bridge (OVS Brkdge) in the target host (Host 2). Then, the first bridge (OVS Brkdge) in the target host (Host 1) is connected to the first bridge (OVS Brkdge) of the target host (Host 2) through a network, where the network tunnel may support Virtual Extensible Local Area Network (VXLAN) protocol, General Routing Encapsulation (GRE) protocol, and so on.

Meanwhile, the container (container1) and the container (container2) in the target host (Host1) are connected with the second bridge (Linux Brkdge) in the target host (Host 1) through the management interface (mgmt), and the container (container3) and the container (container4) in the target host (Host 2) are connected with the second bridge (Linux Brkdge) in the target host (Host2). Then, the second bridge (Linux Brkdge) in the target host (Host1) is connected to the second bridge (Linux Brkdge) of the target host (Host2) through a network.

In the embodiments of the present disclosure, the performing emulation verification on the emulated network topology based on the emulation runtime environment to obtain an emulation verification result, comprises the following steps F1-F4.

At step F1, a network verification task is obtained from the network verification request.

At step F2, a network verification strategy and a verification metric are obtained using the network verification task.

At step F3, in the emulation runtime environment, emulation verification is performed on the emulated network topology based on the network verification strategy, to obtain verification data corresponding to the verification metric.

At step F4, the emulation verification result is generated based on the verification metric and the verification data.

In the embodiments of the present disclosure, the network verification task may be directly extracted from the network verification request, and the network verification task may be a loop detection task and a reachability difference task, and so on. The network verification strategy of the reachability difference task is computing an end-to-end accessibility difference of all service types in the emulated network topology. The network verification strategy of the loop detection task is answering “whether a routing loop exists within the network” based on a routing forwarding table of all the emulated network devices.

In the embodiments of the present disclosure, in response to the network verification task being the reachability difference task, the routing forwarding table of the emulated network topology is obtained, where the routing forwarding table includes a direct routing relationship and a non-direct routing relationship between the emulated network topology devices. It can be understood that the direct routing is a routing mode of a subnet connected with the network device interface; the non-direct routing is a routing learned from other network devices through a routing protocol. Then, whether the network devices in the network topology are reachable is verified (that is, whether the direct routing or the non-direct routing in the routing table are affected or changed). Specifically, corresponding detection messages are respectively constructed for a plurality of network devices, and the network devices may send the detection messages to other network devices having the direct routing relationship with the detection messages, and may further send the detection messages to other network devices having the non-direct routing relationship with the network devices. Then, a response message of the detection messages is received. If a message attribute of the response message matches a message attribute of the detection message, then it is determined that the direct routing relationship or the non-direct routing relationship between the network device and other network devices has not changed. On the contrary, if the message attribute of the response message does not match the message attribute of the detection message, then it is determined that the direct routing relationship or the non-direct routing relationship between the network device and other network devices has changed.

In the embodiment of the present disclosure, in response to the network verification task being the loop detection task, the network device generates a loop detection message; the network device queries the routing corresponding to a destination IP address of the loop detection message through the route forwarding table, and sends the loop detection message using the routing. The network device receives the service data message fed back by the routing. When the service data message matches the loop detection message, it may be determined that the network device identifies the routing corresponding to the destination IP address of the loop detection message as loop routing.

According to the method provided by the embodiments of the present disclosure, firstly, the target network device changed in the physical network can be automatically determined using the device change information. Then, the plurality of extended network devices corresponding to the target network device are traversed from the physical network. Moreover, the emulated network topology is constructed based on the target network device and the extended network devices, and the emulation runtime environment corresponding to the emulated network topology is established. At last, emulation verification is performed on the emulated network topology to obtain an emulation verification result. Therefore, related extended devices are automatically traversed based on the changed devices, and the emulated network topology is established, so that the automatic establishment of the emulated network topology is achieved, and manual establishment is not needed even for a large-scale network topology. In addition, after the emulated network topology is established, the network can be automatically verified, and efficiency of network verification is improved.

The embodiments further provide an apparatus for network topology-based verification, and the apparatus is used to implement the foregoing embodiments and preferred embodiments, and details of which have been already described are not repeated. As used below, the term “module” may be a combination of software and/or hardware that implements a predetermined function. Although the means described in the embodiments below are preferably implemented in software, an implementation in hardware or a combination of software and hardware is also possible and contemplated.

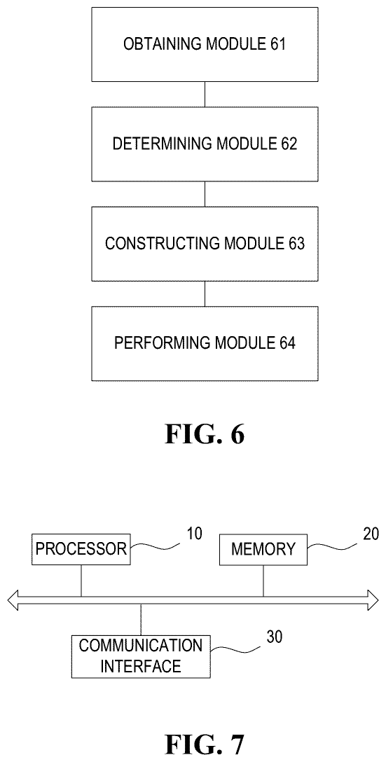

The embodiments provide an apparatus for network topology-based verification, as shown in FIG. 6, comprising: an obtaining module 61 configured to obtain a network verification request, wherein the network verification request comprises device change information for a physical network, the physical network comprises a plurality of hierarchical layers, and each of the hierarchical layers comprises a plurality of network devices; a determining module 62 configured to determine a target network device changed in the physical network using the device change information, and obtain extended network devices from network devices in each of the hierarchical layers in the physical network, where the extended network devices obtained in each of the hierarchical layers correspond to different providers; a constructing module 63 configured to construct an emulated network topology based on the target network device and the extended network devices; and a performing module 64 configured to establish an emulation runtime environment corresponding to the emulated network topology, and perform emulation verification on the emulated network topology based on the emulation runtime environment to obtain an emulation verification result.

In the embodiments of the present disclosure, the determining module 62 is configured to traverse the physical network to obtain a set of upstream network devices and a set of downstream network devices associated with the target network device, where the set of upstream network devices comprise target upstream network devices at the plurality of hierarchical layers, and the set of downstream network devices comprise target downstream network devices at the plurality of hierarchical layers; traverse the physical network to obtain a target neighboring device at a same hierarchical layer as the target network device; and determine the target upstream network devices, the target downstream network devices, and the target neighboring device as the extended network devices.

In the embodiments of the present disclosure, the determining module 62 is configured to traverse the physical network to obtain a first set of devices at an upper hierarchical layer than that of the target network device and a second set of devices at a lower hierarchical layer than that of the target network device, where the first set of devices comprises a plurality of upstream network devices, and the second set of devices comprises a plurality of downstream network devices; determine a set of first providers corresponding to the first set of devices and a set of second providers corresponding to the second set of devices, where the set of first providers comprises a plurality of different first providers, and the set of second providers comprises a plurality of different second providers; select an upstream network device corresponding to each of the first providers from the first set of devices as the target upstream network device, and adding the target upstream network device to the set of upstream network devices; and select a downstream network device corresponding to each of the second providers from the second set of devices as the target downstream network device, and add the target downstream network device to the set of downstream network devices.

In the embodiments of the present disclosure, the determining module 62 is configured to detect whether respective upstream network devices in the first set of devices belong to a root node, to obtain a first detection result; determine an upstream network device with the first detection result of not belonging to a vertex as a reference upstream network device, and traversing the physical network to obtain a third set of devices of an upper hierarchical layer of the reference upstream network device, where the third set of devices comprises a plurality of upstream network devices; determine a set of third providers corresponding to the third set of devices, where the set of third providers comprises a plurality of different third providers; and select an upstream network device corresponding to each of the third providers from the third set of devices as the target upstream network device, and add the target upstream network device to the set of upstream network devices until the upstream network devices belonging to the root node have been traversed.

In the embodiments of the present disclosure, the determining module 62 is configured to detect whether respective downstream network devices in the second set of devices belong to a leaf node, to obtain a second detection result; determine a downstream network device with the second detection result of not belonging to the leaf node as a reference downstream network device, and traverse the physical network to obtain a fourth set of devices of a lower hierarchical layer of the reference downstream network device, where the fourth set of devices comprises a plurality of downstream network devices; determine a fourth provider set corresponding to the fourth set of devices, where the fourth provider set comprises a plurality of different fourth providers; and select a downstream network device corresponding to each of the fourth providers from the fourth set of devices as the target downstream network device, and add the target downstream network device to the set of downstream network devices until the downstream network devices belonging to the leaf node have been traversed.

In the embodiments of the present disclosure, the determining module 62 is configured to traverse the physical network to obtain candidate neighboring devices at a same hierarchical layer as the target network device; and determine a candidate neighboring device with no device change as the target neighboring device.

In the embodiments of the present disclosure, the constructing module 63 is configured to determine a first connection relationship between the target network device and the extended network devices, and second connection relationships between respective ones of the extended network devices; and establish the emulated network topology based on the target network device, the extended network devices, the first connection relationship, and the second connection relationships.

In the embodiments of the present disclosure, the apparatus further comprises: a pruning module configured to obtain a set of links between every two network devices in the emulated network topology, where the set of links comprises at least one original link for connecting two network devices; prune the original link in the set of links to obtain a pruned target link; and update the set of links based on the target link.

In the embodiments of the present disclosure, the pruning module is configured to remove a first link number of original links from the set of links to obtain a second link number of remaining original links; compare the second link number with a predetermined link number; and in response to the second link number being greater than or equal to the predetermined link number, determine the remaining original links corresponding to the second link number as the target link.

In the embodiments of the present disclosure, the pruning module is configured to in response to the second link number being less than the predetermined link number, determine a difference value between the second link number and the predetermined link number; obtain, from the first link number of original links, an original link corresponding to the difference value; and determine the original link corresponding to the difference value and the remaining original links corresponding to the second link number as the target link.

In the embodiments of the present disclosure, the performing module 64 is configured to obtain a hierarchical layer number of the emulated network topology; determine a corresponding number of target hosts based on the hierarchical layer number, and determine a container number in the target hosts based on a device number of network devices at each of the hierarchical layers; deploy the container number of containers in the target hosts; and establish a connection relationship between respective containers in the target hosts and a connection relationship between containers in different target hosts, to obtain the emulation runtime environment.

In the embodiments of the present disclosure, the performing module 64 is configured to determine a virtual machine to be deployed to respective containers in the host, and obtain a virtual machine image and a virtual machine boot program of the virtual machine; generate a container image based on the virtual machine image, the virtual machine boot program and a predetermined software library; and create the container using the container image.

In the embodiments of the present disclosure, the performing module 64 is configured to connect respective containers in the target hosts through virtual network card ports in the containers; connect Ethernet interfaces of respective containers in the target hosts to first bridges, and connect, using a network tunnel, the first bridges in respective target hosts; and connect management interfaces of respective containers in the target hosts to second bridges, and connecting the second bridges in the respective target hosts to obtain the emulation runtime environment.

In the embodiments of the present disclosure, the performing module 64 is configured to obtain a network verification task from the network verification request; obtain, using the network verification task, a network verification strategy and a verification metric; perform, in the emulation runtime environment, emulation verification on the emulated network topology based on the network verification strategy, to obtain verification data corresponding to the verification metric; and generate the emulation verification result based on the verification metric and the verification data.

The embodiments of the present disclosure further provide an electronic device, as shown in FIG. 7, the electronic device may include: a processor 1501, a communication interface 1502, a memory 1503 and a communication bus 1504, where the processor 1501, the communication interface 1502 and the memory 1503 communicate with each other through the communication bus 1504.

The memory 1503 is configured for storing a computer program;

The processor 1501 is configured to implement the steps of the foregoing embodiments when executing the computer program stored in the memory 1503.

The communication bus mentioned in the above terminal may be a Peripheral Component Interconnect (PCI) bus, an Extended Industry Standard Architecture (EISA) bus, or the like. The communication bus may be divided into an address bus, a data bus, a control bus, or the like. For ease of illustration, only one thick line is shown, but this is not intended to represent only one bus or type of bus.

The communication interface is configured for communication between the terminal and other devices.

The memory may include a Random Access Memory (RAM), and may also include a non-volatile memory, such as at least one disk memory. Alternatively, the memory may be at least one storage device away from the aforementioned processor.

The aforementioned processor may be a general-purpose processor, including a Central Processing Unit (CPU), a Network Processor (NP), and the like, It can also be a Digital Signal Processor (DSP), an Application Specific Integrated Circuit (ASIC), a Field-Programmable Gate Array (FPGA) or other Programmable logic devices, discrete gates or transistor logic devices, or discrete hardware components.

In another embodiment provided by the present disclosure, a computer-readable storage medium is further provided, where instructions are stored in the computer-readable storage medium, and when the instructions are executed on a computer, the instructions cause the computer to perform the method of network topology-based verification according to any of the above embodiments.

In yet another embodiment provided by the present disclosure, there is also provided a computer program product containing instructions that, when executed on a computer, cause the computer to perform the method of network topology-based verification according to any of the above embodiments.

In the above embodiments, all or part of the implementation may be physicalized by software, hardware, firmware, or any combination thereof. When implemented in software, it may be implemented in whole or in part in the form of a computer program product. The computer program product includes one or more computer instructions. The procedures or functions described in accordance with the embodiments of the disclosure are all or partially produced when the computer program instructions are loaded and executed on a computer. The computer may be a general-purpose computer, a special purpose computer, a network of computers, or other programmable devices. The computer instructions may be stored in a computer readable storage medium or transmitted from a computer readable storage medium to another computer readable storage medium, for example, the computer instructions may be transmitted from a website, a computer, a server, or a data center to another website, computer, server, or data center through wired (e.g., coaxial cable, fiber optic, digital subscriber line) or wireless (e.g., infrared, wireless, or microwave, etc.). The computer-readable storage medium may be any available medium that can be accessed by a computer or a data storage device, such as a server, a data center, etc., that includes one or more available medium. The available medium may be a magnetic medium (e.g., floppy disk, hard disk, magnetic tape), an optical medium (e.g., DVD), or a semiconductor medium (e.g., Solid State Disk), and so on.

The above description is only for the preferred embodiment of the present disclosure, and is not intended to limit the scope of the present disclosure. Any modification, equivalent replacement, improvement or the like made within the spirit and principle of the present disclosure is included in the protection scope of the present disclosure.

The previous description is only for the purpose of describing particular embodiments of the present disclosure, so as to enable those skilled in the art to understand or implement the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Although the embodiments of the present disclosure have been described in conjunction with the accompanying drawings, those skilled in the art may make various modifications and variations without departing from the spirit and scope of the present disclosure, and such modifications and variations are within the scope defined by the appended claims.

1. A method of network topology-based verification, comprising:
obtaining a network verification request, wherein the network verification request comprises device change information for a physical network, the physical network comprises a plurality of hierarchical layers, and each of the hierarchical layers comprises a plurality of network devices;
determining a target network device changed in the physical network using the device change information, and obtaining extended network devices from network devices in each of the hierarchical layers in the physical network, wherein the extended network devices obtained in each of the hierarchical layers correspond to different providers;
constructing an emulated network topology based on the target network device and the extended network devices; and
establishing an emulation runtime environment corresponding to the emulated network topology, and performing emulation verification on the emulated network topology based on the emulation runtime environment to obtain an emulation verification result.

2. The method of claim 1, wherein the obtaining extended network devices from network devices in each of the hierarchical layers in the physical network comprises:
traversing the physical network to obtain a set of upstream network devices and a set of downstream network devices associated with the target network device, wherein the set of upstream network devices comprise target upstream network devices at the plurality of hierarchical layers, and the set of downstream network devices comprise target downstream network devices at the plurality of hierarchical layers;
traversing the physical network to obtain a target neighboring device at a same hierarchical layer as the target network device; and
determining the target upstream network devices, the target downstream network devices, and the target neighboring device as the extended network devices.

3. The method of claim 2, wherein the traversing the physical network to obtain an set of upstream network devices and a set of downstream network devices associated with the target network device comprises:
traversing the physical network to obtain a first set of devices at an upper hierarchical layer than that of the target network device and a second set of devices at a lower hierarchical layer than that of the target network device, wherein the first set of devices comprises a plurality of upstream network devices, and the second set of devices comprises a plurality of downstream network devices;
determining a set of first providers corresponding to the first set of devices and a set of second providers corresponding to the second set of devices, wherein the set of first providers comprises a plurality of different first providers, and the set of second providers comprises a plurality of different second providers;
selecting an upstream network device corresponding to each of the first providers from the first set of devices as the target upstream network device, and adding the target upstream network device to the set of upstream network devices; and
selecting a downstream network device corresponding to each of the second providers from the second set of devices as the target downstream network device, and adding the target downstream network device to the set of downstream network devices.

4. The method of claim 3, wherein after selecting an upstream network device corresponding to each of the first providers from the first set of devices as the target upstream network device, and adding the target upstream network device to the set of upstream network devices, the method further comprises:
detecting whether respective upstream network devices in the first set of devices belong to a root node, to obtain a first detection result;
determining an upstream network device with the first detection result of not belonging to a vertex as a reference upstream network device, and traversing the physical network to obtain a third set of devices of an upper hierarchical layer of the reference upstream network device, wherein the third set of devices comprises a plurality of upstream network devices;
determining a set of third providers corresponding to the third set of devices, wherein the set of third providers comprises a plurality of different third providers; and
selecting an upstream network device corresponding to each of the third providers from the third set of devices as the target upstream network device, and adding the target upstream network device to the set of upstream network devices until the upstream network devices belonging to the root node have been traversed.

5. The method of claim 4, wherein after selecting a downstream network device corresponding to each of the second providers from the second set of devices as the target downstream network device, and adding the target downstream network device to the set of downstream network devices, the method further comprises:
detecting whether respective downstream network devices in the second set of devices belong to a leaf node, to obtain a second detection result;
determining a downstream network device with the second detection result of not belonging to the leaf node as a reference downstream network device, and traversing the physical network to obtain a fourth set of devices of a lower hierarchical layer of the reference downstream network device, wherein the fourth set of devices comprises a plurality of downstream network devices;
determining a fourth provider set corresponding to the fourth set of devices, wherein the fourth provider set comprises a plurality of different fourth providers; and
selecting a downstream network device corresponding to each of the fourth providers from the fourth set of devices as the target downstream network device, and adding the target downstream network device to the set of downstream network devices until the downstream network devices belonging to the leaf node have been traversed.

6. The method of claim 2, wherein the traversing the physical network to obtain a target neighboring device at a same hierarchical layer as the target network device comprises:
traversing the physical network to obtain candidate neighboring devices at a same hierarchical layer as the target network device; and
determining a candidate neighboring device with no device change as the target neighboring device.

7. The method of claim 1, wherein the establishing an emulated network topology based on the target network device and the extended network devices comprises:
determining a first connection relationship between the target network device and the extended network devices, and second connection relationships between respective ones of the extended network devices; and
establishing the emulated network topology based on the target network device, the extended network devices, the first connection relationship, and the second connection relationships.

8. The method of claim 7, further comprising:
obtaining a set of links between every two network devices in the emulated network topology, wherein the set of links comprises at least an original link for connecting two network devices;
pruning the original link in the set of links to obtain a pruned target link; and
updating the set of links based on the target link.

9. The method of claim 8, wherein the pruning the original link in the set of links to obtain a pruned target link comprises:
removing a first link number of original links from the set of links to obtain a second link number of remaining original links;
comparing the second link number with a predetermined link number; and
in response to the second link number being greater than or equal to the predetermined link number, determining the remaining original links corresponding to the second link number as the target link.

10. The method of claim 9, wherein after comparing the second link number with a predetermined link number, the method further comprises:
in response to the second link number being less than the predetermined link number, determining a difference value between the second link number and the predetermined link number;
obtaining, from the first link number of original links, an original link corresponding to the difference value; and
determining the original link corresponding to the difference value and the remaining original links corresponding to the second link number as the target link.

11. The method of claim 1, wherein the establishing an emulation runtime environment corresponding to the emulated network topology comprises:
obtaining a hierarchical layer number of the emulated network topology;
determining a corresponding number of target hosts based on the hierarchical layer number, and determining a container number in the target hosts based on a device number of network devices at each hierarchical layer;
deploying the container number of containers in the target hosts; and
establishing a connection relationship between respective containers in the target hosts and a connection relationship between containers in different target hosts, to obtain the emulation runtime environment.

12. The method of claim 11, wherein the deploying the container number of containers in the target hosts comprises:
determining a virtual machine to be deployed to respective containers in the host, and obtaining a virtual machine image and a virtual machine boot program of the virtual machine;
generating a container image based on the virtual machine image, the virtual machine boot program and a predetermined software library; and
creating the container using the container image.

13. The method of claim 11, wherein the establishing a connection relationship between respective containers with the target hosts and a connection relationship between containers in different target hosts, to obtain the emulation runtime environment, comprises:
connecting respective containers in the target hosts through virtual network card ports in the containers;
connecting Ethernet interfaces of respective containers in the target hosts to first bridges, and connecting, using a network tunnel, the first bridges in respective target hosts; and
connecting management interfaces of respective containers in the target hosts to second bridges, and connecting the second bridges in the respective target hosts to obtain the emulation runtime environment.

14. The method of claim 1, wherein the performing emulation verification on the emulated network topology based on the emulation runtime environment to obtain an emulation verification result, comprising:
obtaining a network verification task from the network verification request;
obtaining, using the network verification task, a network verification strategy and a verification metric;
performing, in the emulation runtime environment, emulation verification on the emulated network topology based on the network verification strategy, to obtain verification data corresponding to the verification metric; and
generating the emulation verification result based on the verification metric and the verification data.

15. A computer device, comprising:
a memory and a processor, wherein the memory and the processor are in communication with each other, the memory stores computer instructions which are executed by the processor to perform operations comprising:
obtaining a network verification request, wherein the network verification request comprises device change information for a physical network, the physical network comprises a plurality of hierarchical layers, and each of the hierarchical layers comprises a plurality of network devices;
determining a target network device changed in the physical network using the device change information, and obtaining extended network devices from network devices in each of the hierarchical layers in the physical network, wherein the extended network devices obtained in each of the hierarchical layers correspond to different providers;
constructing an emulated network topology based on the target network device and the extended network devices; and
establishing an emulation runtime environment corresponding to the emulated network topology, and performing emulation verification on the emulated network topology based on the emulation runtime environment to obtain an emulation verification result.

16. The computer device of claim 15, wherein the obtaining extended network devices from network devices in each of the hierarchical layers in the physical network comprises:
traversing the physical network to obtain a set of upstream network devices and a set of downstream network devices associated with the target network device, wherein the set of upstream network devices comprise target upstream network devices at the plurality of hierarchical layers, and the set of downstream network devices comprise target downstream network devices at the plurality of hierarchical layers;
traversing the physical network to obtain a target neighboring device at a same hierarchical layer as the target network device; and
determining the target upstream network devices, the target downstream network devices, and the target neighboring device as the extended network devices.

17. The computer device of claim 16, wherein the traversing the physical network to obtain an set of upstream network devices and a set of downstream network devices associated with the target network device comprises:
traversing the physical network to obtain a first set of devices at an upper hierarchical layer than that of the target network device and a second set of devices at a lower hierarchical layer than that of the target network device, wherein the first set of devices comprises a plurality of upstream network devices, and the second set of devices comprises a plurality of downstream network devices;
determining a set of first providers corresponding to the first set of devices and a set of second providers corresponding to the second set of devices, wherein the set of first providers comprises a plurality of different first providers, and the set of second providers comprises a plurality of different second providers;
selecting an upstream network device corresponding to each of the first providers from the first set of devices as the target upstream network device, and adding the target upstream network device to the set of upstream network devices; and
selecting a downstream network device corresponding to each of the second providers from the second set of devices as the target downstream network device, and adding the target downstream network device to the set of downstream network devices.

18. The computer device of claim 17, wherein after selecting an upstream network device corresponding to each of the first providers from the first set of devices as the target upstream network device, and adding the target upstream network device to the set of upstream network devices, the method further comprises:
detecting whether respective upstream network devices in the first set of devices belong to a root node, to obtain a first detection result;
determining an upstream network device with the first detection result of not belonging to a vertex as a reference upstream network device, and traversing the physical network to obtain a third set of devices of an upper hierarchical layer of the reference upstream network device, wherein the third set of devices comprises a plurality of upstream network devices;
determining a set of third providers corresponding to the third set of devices, wherein the set of third providers comprises a plurality of different third providers; and
selecting an upstream network device corresponding to each of the third providers from the third set of devices as the target upstream network device, and adding the target upstream network device to the set of upstream network devices until the upstream network devices belonging to the root node have been traversed.

19. The computer device of claim 18, wherein after selecting a downstream network device corresponding to each of the second providers from the second set of devices as the target downstream network device, and adding the target downstream network device to the set of downstream network devices, the method further comprises:
detecting whether respective downstream network devices in the second set of devices belong to a leaf node, to obtain a second detection result;
determining a downstream network device with the second detection result of not belonging to the leaf node as a reference downstream network device, and traversing the physical network to obtain a fourth set of devices of a lower hierarchical layer of the reference downstream network device, wherein the fourth set of devices comprises a plurality of downstream network devices;
determining a fourth provider set corresponding to the fourth set of devices, wherein the fourth provider set comprises a plurality of different fourth providers; and
selecting a downstream network device corresponding to each of the fourth providers from the fourth set of devices as the target downstream network device, and adding the target downstream network device to the set of downstream network devices until the downstream network devices belonging to the leaf node have been traversed.

20. A non-transitory computer-readable storage medium having computer instructions stored thereon, wherein the computer instructions are configured to cause a computer to perform operations comprising:
obtaining a network verification request, wherein the network verification request comprises device change information for a physical network, the physical network comprises a plurality of hierarchical layers, and each of the hierarchical layers comprises a plurality of network devices;
determining a target network device changed in the physical network using the device change information, and obtaining extended network devices from network devices in each of the hierarchical layers in the physical network, wherein the extended network devices obtained in each of the hierarchical layers correspond to different providers;
constructing an emulated network topology based on the target network device and the extended network devices; and
establishing an emulation runtime environment corresponding to the emulated network topology, and performing emulation verification on the emulated network topology based on the emulation runtime environment to obtain an emulation verification result.
